(19) United States
(12) Patent Application Publication
(10) Pub. No.: US 2019/0034949 A1
(43) Pub. Date: Jan. 31, 2019

(54) SYSTEM AND METHOD FOR PROVIDING VARIABLE REWARDS THROUGH A GAME INTERFACE OF AN ELECTRONIC DEVICE

(71) Applicant: GameIQ, Inc., Carlsbad, CA (US)

(72) Inventor: Balazs Wellisch, Carlsbad, CA (US)

(21) Appl. No.: 16/017,846

(22) Filed: Jun. 25, 2018

Related U.S. Application Data
(60) Provisional application No. 62/537,888, filed on Jul. 27, 2017.

(51) Int. Cl. G06Q 30/02

(52) U.S. Cl. CPC G06Q 30/0212; G06Q 30/0235; G06Q 30/0234

(57) ABSTRACT

A computer-implemented method of acquiring variable rewards via a user device. The method includes displaying, by a variable rewards application executing on the user device, an offer for a variable reward associated with a merchant. The user device receives user input causing the variable reward to be claimed. A camera of the user device creates an image of a receipt corresponding to a purchase of a product or a service from the merchant. The image of the receipt is electronically sent over a network to a variable rewards platform. The user device receives variable rewards information provided by the variable rewards platform and displays, through a game interface, an amount of a variable reward included within the variable rewards information. A user account maintained by the variable rewards platform is credited based upon the amount of the variable reward.

### CROSS-REFERENCE TO RELATED APPLICATIONS

The present application claims the benefit of priority under 35 U.S.C. § 119(e) of U.S. Provisional Application No. 62/537,888, entitled SYSTEM AND METHOD FOR PROVIDING VARIABLE REWARDS THROUGH A GAME INTERFACE OF AN ELECTRONIC DEVICE, filed Jul. 27, 2017, the content of which is hereby incorporated by reference in its entirety for all purposes.

### FIELD

This disclosure relates generally to a system and method for electronically enabling users to obtain variable rewards in connection with purchase transactions.

### BACKGROUND

Consumer rewards are marketing tools commonly used by commercial retailers to incent consumers to make purchases. Some retail establishments attempt to retain existing patrons, and entice new ones, by offering reward points that may be accrued over time and exchanged for additional products or services. However, these programs typically require that the accumulated reward points be redeemed with the retail establishment from which they were received.

Rebates and group purchasing discounts are also common business strategies employed to encourage consumers to purchase products and services from particular retail establishments. Both of these approaches have drawbacks which may limit their effectiveness. For example, rebates typically require consumers to complete forms, mail them to a sponsoring entity, and wait weeks or months to receive a rebate reward. Group discounts, even those facilitated online, require cooperation or participation of multiple consumers.

Accordingly, it would be a desirable to provide a consumer reward system that enables rewards to be redeemed expeditiously, and which does not require redemption with the entity issuing the rewards. It would also be desirable for the reward system itself to be simple and engaging from the perspective of the consumer.

### SUMMARY

The present disclosure describes a system and method allowing businesses to offer cash rebates to consumers via a variable rewards platform. Consumers desiring to obtain a variable reward from participating businesses download a variable rewards application to their respective personal electronic devices. The variable rewards application may be configured to organize and display all participating business locations, as well as each business' average rebate amount, minimum purchase requirement, maximum rebate amount and all other terms of the rebate offered by the business. Participating businesses may access a merchant portal of the variable rewards platform to set an average reward percentage and a minimum qualifying purchase amount. Users making qualifying purchases of product(s) and/or service(s) from participating merchants may obtain variable rewards through the variable rewards application in the manner discussed below.

In one embodiment a user may search for merchant rewards through the variable rewards application using, for example, geographical search criteria provided by the user or via geolocation options selected by the user. Once a user identifies a desired reward, the user generally will: (i) first, “claim” that reward in the application; (ii) then, purchase the qualifying merchant product(s) or service(s) associated with the reward selected; and (iii) then, use the variable rewards application to photograph the receipt associated with the purchase of the qualifying merchant product(s) or service(s) and upload the same to the application in a format that the application can read and record properly.

Once a sale is verified and approved, in one embodiment the user of the variable rewards application will be permitted to spin a “virtual wheel” presented by the application via a screen or other interface of the user's electronic device for a chance to receive, for example, a cash-back reward ranging from one percent (1%) to one hundred percent (100%) of the purchase price of the product(s) and/or services purchased from the merchant. In one embodiment the variable rewards platform randomly generates a variable reward or rebate amount based upon the applicable business' pre-selected parameters. This randomly generated reward amount, along with other reward amounts associated with alternate rewards present on the virtual wheel is displayed by the variable rewards application, is generally communicated to the variable rewards application before the consumer is prompted to “spin” the “virtual wheel” or “virtual carousel” rendered by the variable rewards application. Once the consumer spins the virtual wheel, the wheel sequentially displays the randomly generated reward amount and the alternate reward amounts until the wheel ceases rotating, at which time only the randomly generated reward amount is displayed by the virtual wheel and/or the consumer is otherwise informed that he or she will be issued a rebate equivalent to the randomly generated rebate amount.

The reward amount determined by the spinning of the virtual wheel will typically immediately appear in the user's account with the variable rewards platform in a pending status. Upon confirmation of the validity of the applicable uploaded receipt by the operator of the variable rewards platform and/or the participating merchant, the reward will be made available in the user's account. Once the rewards amount in a user's account exceeds a predefined amount (e.g., $10.00), a payment equivalent to rewards amount is made transferred to the user's bank account or other financial account.

In summary, embodiments of the variable rewards application may provide end users with the ability to: (a) access and browse certain cash-back reward offers, coupons, discounts and other rebates (individually and collectively, “rewards”) as made available by participating third-party merchants when offered in connection with the purchase of that merchant's products and/or services; (b) search, based on the user's search criteria, for participating merchants offering rewards in a given geographical area, using geo-location technology; (c) claim a reward after the user has purchased (and confirmed the purchase of) the applicable merchant products; (d) spin the virtual wheel to determine the amount of the reward that a user has obtained; (e) access that user's account, view that user's past rewards activity, enter account information and select methods to receive rewards payments.

The variable rewards platform will generally be configured to issue instructions to transfer the rebate payment to the consumer's bank account within a predefined time period, e.g., two weeks. The variable rewards platform will generally not cause rebate payments to be withheld or to require a consumer to take further steps once he or she has completed the rebate submission process via the variable rewards application for a qualifying purchase.

The variable rewards platform will typically include a merchant portal including a Web-based application programming interface and dashboard through which participating merchants may apply for, and access, information and services provided by the variable rewards platform. The platform will generally be configured to enable merchants to track and reward end-user consumers that have downloaded and continue to utilize the variable rewards application with certain cash-back reward offers, coupons, discounts and other rebates, as designated by the applicable merchant, in connection with the purchase the merchant's products and/or services.

In one embodiment each merchant establishes, through the merchant Portal, the: (i) criteria for receiving rewards (e.g., the applicable product of the merchant to be purchased, spending thresholds, etc.) in connection with purchases of the merchant's product(s) and/or service(s); (ii) a monetary amount/range of each reward; and (iii) a number of rewards to be offered to users and/or the applicable “cut-off” amount, or maximum aggregate reward. Upon creating a valid reward offering through the merchant portal, that reward may be searchable by users of the variable rewards application based on, for example, geographical search criteria and/or or via geolocation options selected by such users. The merchant portal will generally provide merchants with access to a “slider” or similar user interface feature capable of being used to adjust the estimated average monetary amount of daily rewards. In addition, the merchant portal will enable merchants to establish a “cut-off” amount, which limits the total dollar amount of daily rewards to a predetermined value, after which no additional rewards shall be offered to users. The variable rewards platform may also enable merchants to utilize buttons to allow users to promote their receipt of rewards by and through social media websites.

In one aspect, disclosed herein is a computer-implemented method of acquiring variable rewards via a user device. The method includes displaying, by a variable rewards application executing on the user device, an offer for a variable reward associated with a merchant. The user device receives user input causing the variable reward to be claimed. A camera of the user device creates an image of a receipt corresponding to a purchase of a product or a service from the merchant. The image of the receipt is electronically sent over a network to a variable rewards platform. The user device receives variable rewards information provided by the variable rewards platform and displays, through a game interface, an amount of a variable reward included within the variable rewards information. A user account maintained by the variable rewards platform is credited based upon the amount of the variable reward.

The disclosure also pertains to a computer-implemented method performed by a variable rewards platform. The method includes providing, to a user device, offer information to cause a variable rewards application executing on the user device to display an offer for a variable reward associated with a merchant. The method further includes receiving, from the user device, an indication that a user of the user device has indicated an intent to claim the variable reward by providing user input to the variable rewards application. An image, created by a camera of the device, of a receipt corresponding to a purchase of a product or a service from the merchant is then received. The method further includes determining, in response to receiving the image of the receipt, an amount of a variable reward corresponding to the purchase. Variable rewards information causing the variable rewards application to display the amount of the variable reward is provided to the user device. A user account maintained by the variable rewards platform is credited based upon the amount of the variable reward.

### BRIEF DESCRIPTION OF THE DRAWINGS

For a better understanding of the nature and objects of various embodiments of the invention, reference should be made to the following detailed description taken in conjunction with the accompanying drawings, wherein:

FIG. 1 illustrates a system including a variable rewards platform in accordance with the disclosure.

FIG. 2 is a block diagram representation of one embodiment of a personal electronic device configured for use within the system of FIG. 1.

FIG. 3 is a flowchart for an exemplary process for using a variable rewards application instantiated on a personal electronic device to obtain a variable reward upon making a qualifying purchase from a participating merchant.

FIGS. 4-9 are exemplary screen shots of user interfaces rendered by the variable rewards application in connection with implementing the process illustrated in FIG. 3.

FIG. 10 illustrates an exemplary distribution of variable rewards as a function of reward percentage.

FIGS. 11-15 depict exemplary user interface screens generated by a merchant portal and rendered by an electronic computing device of an administrator for a participating merchant.

### DETAILED DESCRIPTION

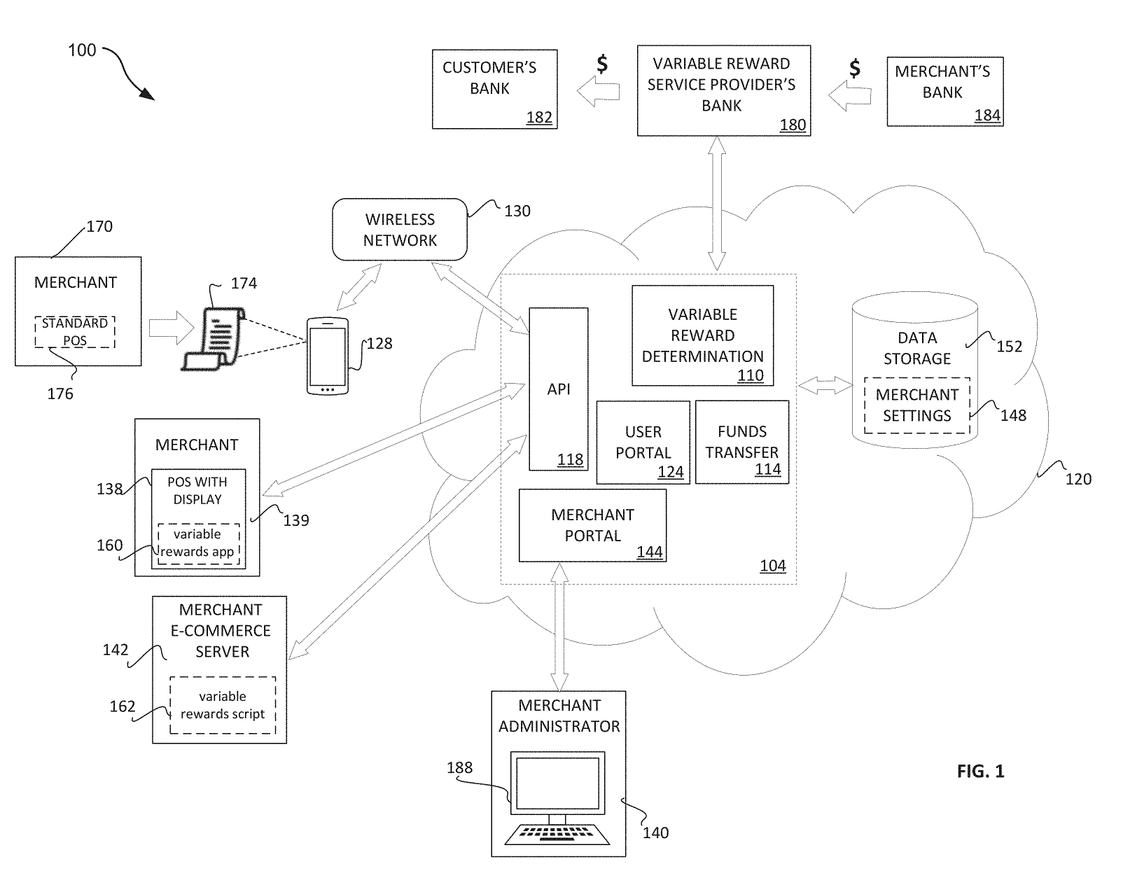

Attention is now directed to FIG. 1, which illustrates a system 100 including a variable rewards platform 104 in accordance with the disclosure. As shown, the variable rewards platform 104 includes a variable reward determination module 110, a funds transfer module 114 and an application programming interface (API) module 118 configured to interface with devices and systems external to the platform 104. The API module 118 may facilitate communication with merchant point-of-sale equipment, merchant e-commerce platforms or servers, and/or user computing device in connection with the determination of variable rewards made in connection with qualifying purchases from participating merchants.

In the embodiment of FIG. 1, the variable rewards platform 104 may be implemented using “cloud” computing capabilities 120. As is known, cloud computing may be characterized as a model for facilitating on-demand network access to a shared pool of configurable computing resources (e.g., networks, servers, storage, applications, and services) that can be rapidly provisioned and released with minimal management effort or service provider interaction. Cloud systems tend to automatically control resource use by utilizing some form of metering capability with respect to, for example, storage, processing, bandwidth, and active user accounts. Various cloud service models are possible, including cloud software as a service (SaaS), cloud platform as a service (PaaS), and cloud infrastructure as a service (IaaS). In one embodiment the platform 104 operates through an Amazon® Web Service Cloud. Of course, in other embodiments some or all of the platform may be implemented using other cloud environments such as, for example, a Microsoft® Azure cloud or another third party cloud.

In other embodiments the variable rewards platform 104 may be implemented by using on-premise servers and other infrastructure rather than by using cloud-based services. Alternatively, hybrid implementations of the variable rewards platform 104 including a combination of on-premise and cloud-based infrastructure are also within the scope of the present disclosure.

Again referring to FIG. 1, the platform 104 includes a user portal module 124 for providing a portal through which customers may complete a registration process using, for example, a personal electronic device 128 (e.g., a smartphone or electronic tablet). In one embodiment the personal electronic device 128 downloads, from the user portal 124 via a wireless network 130, a variable rewards application through which the registration process is completed.

The platform 104 also includes a variable rewards determination module 134 for receiving requests for variable rewards from the personal electronic devices 128 of users, a merchant point-of-sale (POS) 138 located at a merchant premises 139, and/or merchant e-commerce infrastructure 142. The variable rewards determination module 134 is configured to determine, in a randomized fashion descried hereinafter and within constraints defined by participating merchants, the amounts of variable rewards issued to users in connection with qualifying purchases of goods and/or services offered by such merchants. In one embodiment merchant administrators 140 are able to specify such constraints and other reward criteria through a merchant portal 144, which is configured to store this information as merchant settings 148 in database 152.

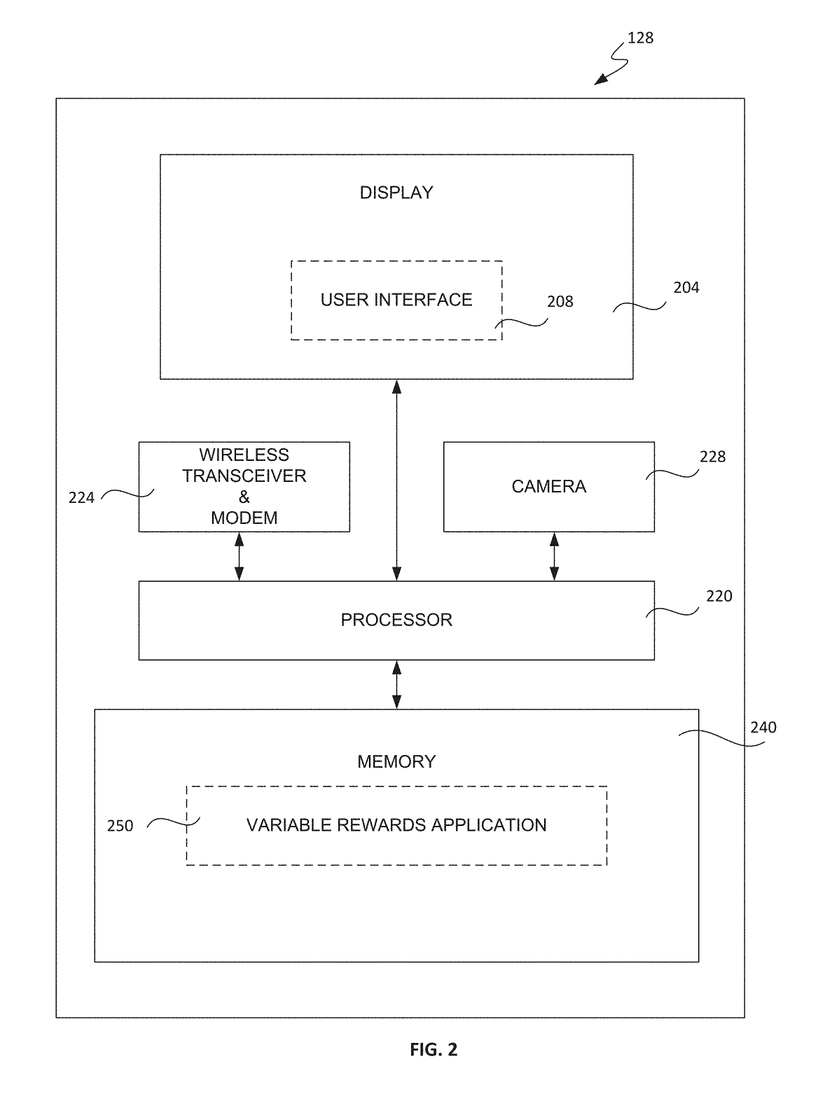

Attention is now directed to FIG. 2, which includes a block diagram representation of one embodiment of the personal electronic device 128, in this case a mobile or cellular phone. It will be apparent that certain details and features of the electronic device 128 have been omitted for clarity, however, in various implementations, various additional features of a mobile device as are known will be included. The device 128 is in communication with the platform 104 via a communications link which may include, for example, the Internet, a wireless network 130 such as a cellular network and/or other wired or wireless networks. The personal electronic device includes a processor 220 operatively coupled to a touch-sensitive display 204 configured to present a user interface 208. In other embodiments the user interface 208 may include a physical keypad or keyboard, audio input device and/or any other device capable of receiving user input or instructions. The device 128 may also include a wireless transceiver and modem 224, a camera 228, and a memory 240 comprised of one or more of, for example, random access memory (RAM), read-only memory (ROM), flash memory and/or any other media enabling the processor 220 to store and retrieve data. As shown, the memory 240 stores a variable rewards application 250 and other programs and/or instructions executable by the processor 220.

In what follows the disclosure will generally make reference to the variable rewards application 250 stored within the device 128 when discussing the operation of the platform 104. As is discussed further below, a user of the device 128 which makes a qualifying purchase from a merchant 170 may receive a physical receipt 174 (e.g., a paper receipt) generated by conventional point of sale (POS) equipment 176. In one embodiment the variable rewards application 250 is configured to enable the user of the device 128 to scan the receipt 174 using the camera 228 and upload it to the platform 104. This informs the platform 104 of the purchase from merchant 170 made by the user of the device 128 and enables the platform 104 to initiate the process of determining an appropriate variable reward associated with such purpose. However, in other embodiments the platform 104 may be similarly informed of such qualifying purchases through other means. For example, the variable rewards application 160 instantiated within the display-enabled POS 138 is configured to communicate similar qualifying purchase information associated with merchant 139 to platform 104 through wired and/or wireless networks (not shown). Similarly, variable rewards script 162 (e.g., Java script) may send, through one or more wired networks such as the Internet, the same or similar purchase information to platform 104 in connection with qualifying e-commerce transactions.

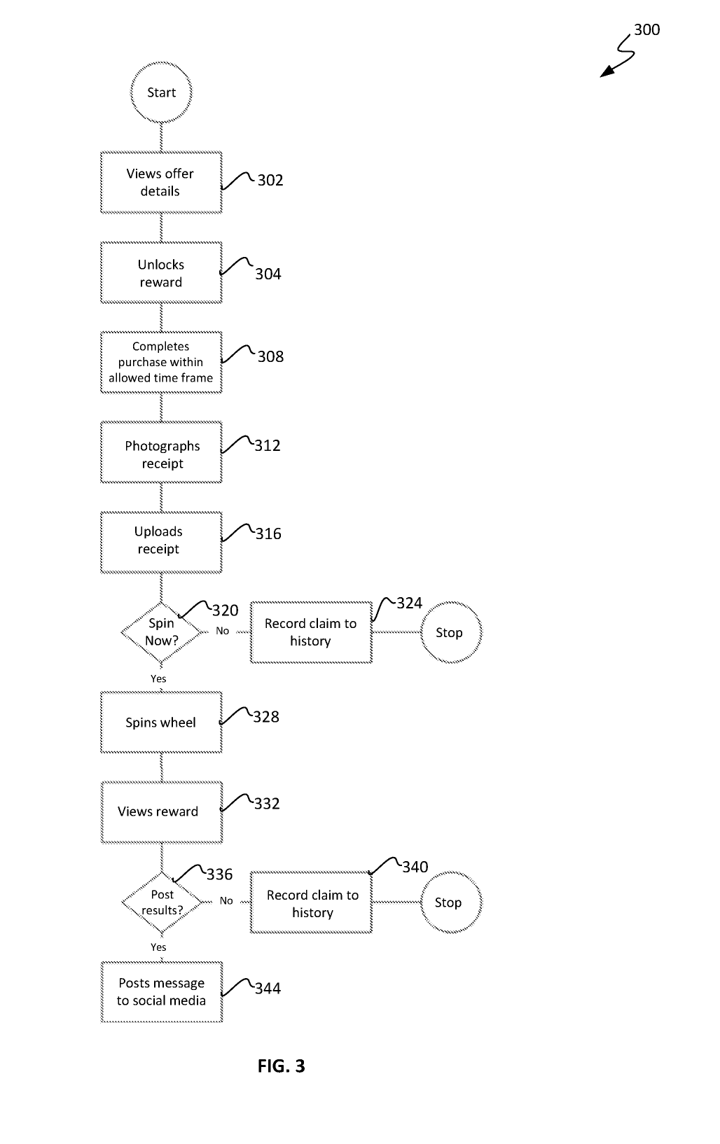

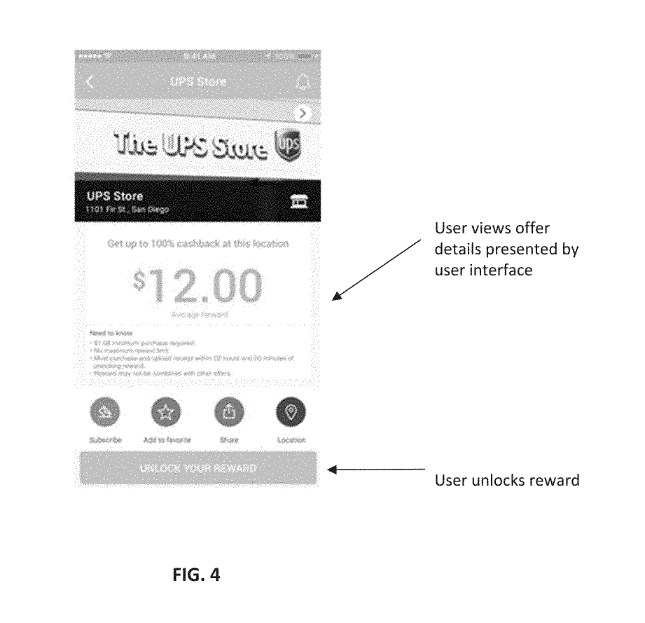

Turning now to FIG. 3, a flowchart is provided for an exemplary process 300 for using the variable rewards application 250 to obtain a variable reward upon making a qualifying purchase from a participating merchant. Exemplary screen shots of user interfaces rendered by the application 250 in connection with the stages of the process 300 are depicted in FIGS. 4-9. In one embodiment a user may search for and view merchant rewards through the variable rewards application 250 using, for example, geographical search criteria provided by the user or via geolocation options selected by the user (stage 302; FIG. 4). For example, the user of the application 250 may request that only restaurants offering variable rewards that are located within a predefined distance of a current location of the user be listed or identified by a user of the application 250. Alternatively, a user could request the application to identify only those restaurants or other retail establishments within a predefined range of the user that are currently offering an average variable reward greater than a predefined percentage of a qualifying purchase amount.

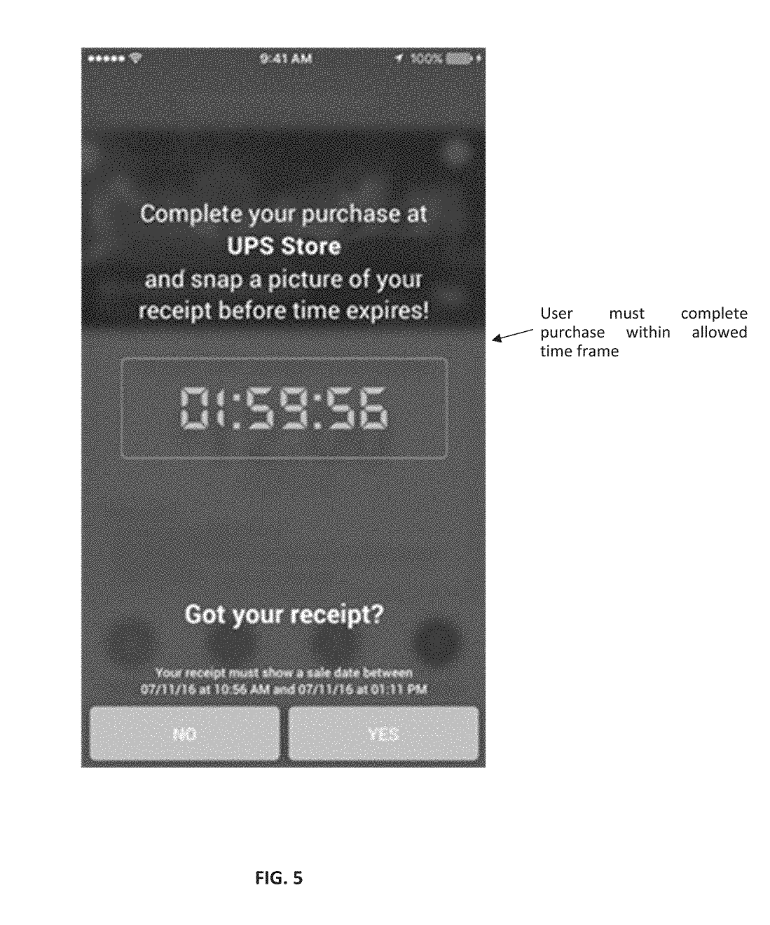

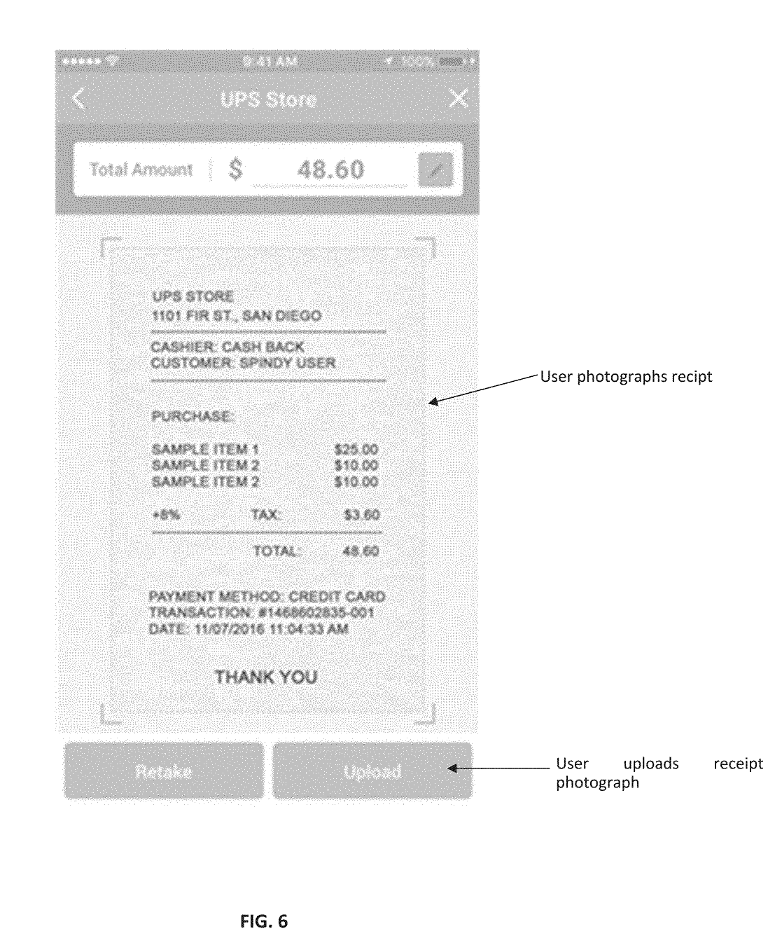

Once a user views a desired reward (stage 302; FIG. 4), the user generally must first “unlock” or otherwise claim that reward in the application 250 (stage 304; FIG. 4). This provides the user with a predetermined amount of time to purchase the qualifying merchant product(s) or service(s) associated with the unlocked reward (FIG. 5). Next, the user purchases such qualifying merchant product(s) or service(s) within the predefined time period (stage 308). The user then utilizes the variable rewards application 250 to photograph the receipt associated with the purchase of the qualifying merchant product(s) or service(s) (stage 312; FIG. 6) and upload the same to the application in a format that the application can read and record properly (stage 316; FIG. 6).

In one embodiment the variable reward determination module 110 may use optical character recognition (OCR) technology to extract a transaction record from each receipt uploaded to the platform 104. This record may include, for example, the name of the participating merchant establishment, the date/time of the purchase and the total amount of the transaction (and/or an adjusted amount equivalent to the total amount less taxes and fees). In addition, the variable reward determination module 110 may implement machine intelligence or utilize machine learning to validate the parameters of the transaction. For example, a purchase amount from a restaurant exceeding $1,000 could be flagged as suspect.

The reward determination module 110 also validates that the purchase was made within the applicable predetermined time period beginning when the reward was “unlocked” by the user. In one embodiment a participating merchant may receive a transaction report or transaction validation information provided by the module 110 and determine whether or not to pay the variable reward associated with the transaction; in other embodiments whether or not to a given transaction is deemed to be a valid qualifying transaction (for purposes of payment of a variable reward) is within the sole discretion of the operator of the platform 104.

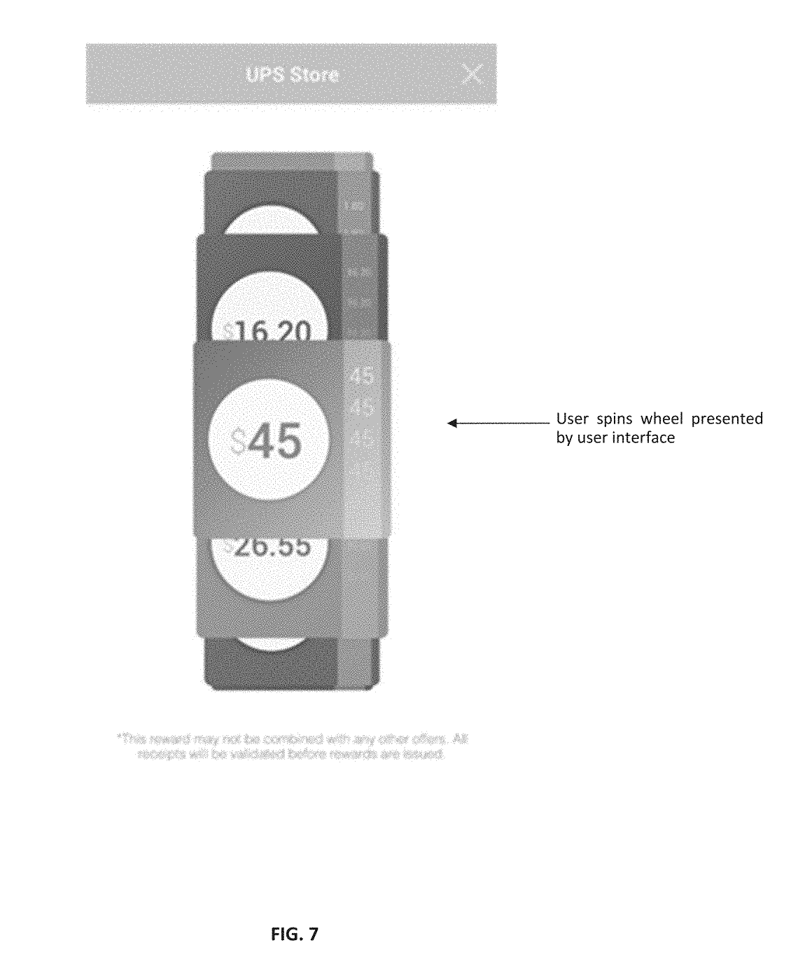

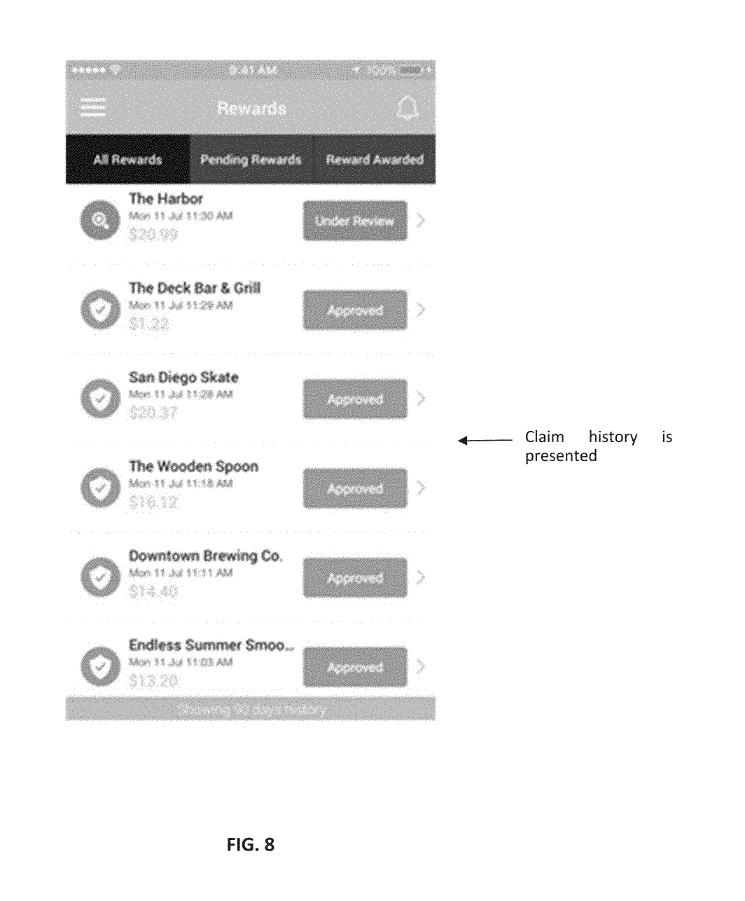

Once a sale is verified and approved, in one embodiment the user of the variable rewards application will be permitted to spin a “virtual wheel” generated by the application 250 and presented on the display 204 for a chance to receive, for example, a cash-back reward ranging from one percent (1%) to one hundred percent (100%) of the purchase price of the product(s) and/or services purchased from the merchant (stage 328; FIG. 7). The user may also decide not to immediately spin the virtual wheel (stage 320) and instead record the claim to a history associated with the user's account (stage 324; FIG. 8); the user could then opt to exercise this recorded claim to variable reward by spinning the virtual wheel at a later time.

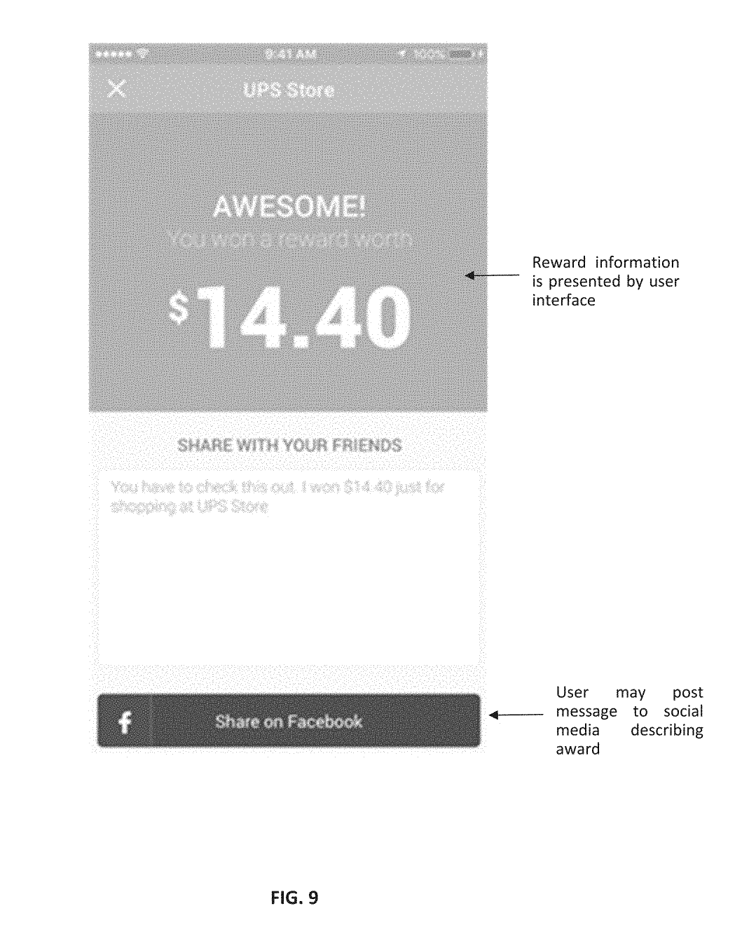

In one embodiment the variable reward determination module 110 randomly generates a rebate amount based upon the applicable business' pre-selected parameters. This randomly generated rebate amount, along with other rebate amounts associated with alternate rebates present on the virtual wheel displayed by the variable rewards application, is generally determined by the module 110 and communicated to the variable rewards application 250 before the consumer is prompted to “spin” the “virtual wheel” or “virtual carousel” (stage 328). Once the consumer spins the virtual wheel, the wheel sequentially displays the randomly generated rebate amount and the alternate rebate amounts provided by the module 110 until the wheel ceases rotating, at which time only the randomly generated rebate amount is displayed by the virtual wheel and/or the consumer is otherwise informed that he or she will be issued a rebate equivalent to the randomly generated rebate amount (stage 332; FIG. 9). The variable rewards application 250 may also be configured to permit merchants to direct that the application 250 present virtual buttons or other icons permitting users to promote their receipt of rewards by and through social media websites. If a user opts to post their award to social media (stage 336), then the user selects the appropriate button or other icon from the user interface of the application (stage 344; FIG. 9); otherwise, the user may elect to record the variable reward claim to a claim history section of the user's account (stage 340).

In other embodiments the user interface of the variable rewards application 250 may be configured to provide the variable reward claimed by the user in an alternative manner. For example, in one embodiment a user may be prompted to “shake” the personal electronic device 129 rather than to virtually spin a wheel or carousel in order to cause the amount of the variable reward to be displayed by the application 250. Another approach that could be used would be to configure the variable rewards application 250 to present a virtual “scratch off” card. In this case the user interface of the application 250 would reveal the variable reward after the user had interacted with the application 250 in such a way to “scratch off” the appropriate portion(s) of the virtual scratch-off card.

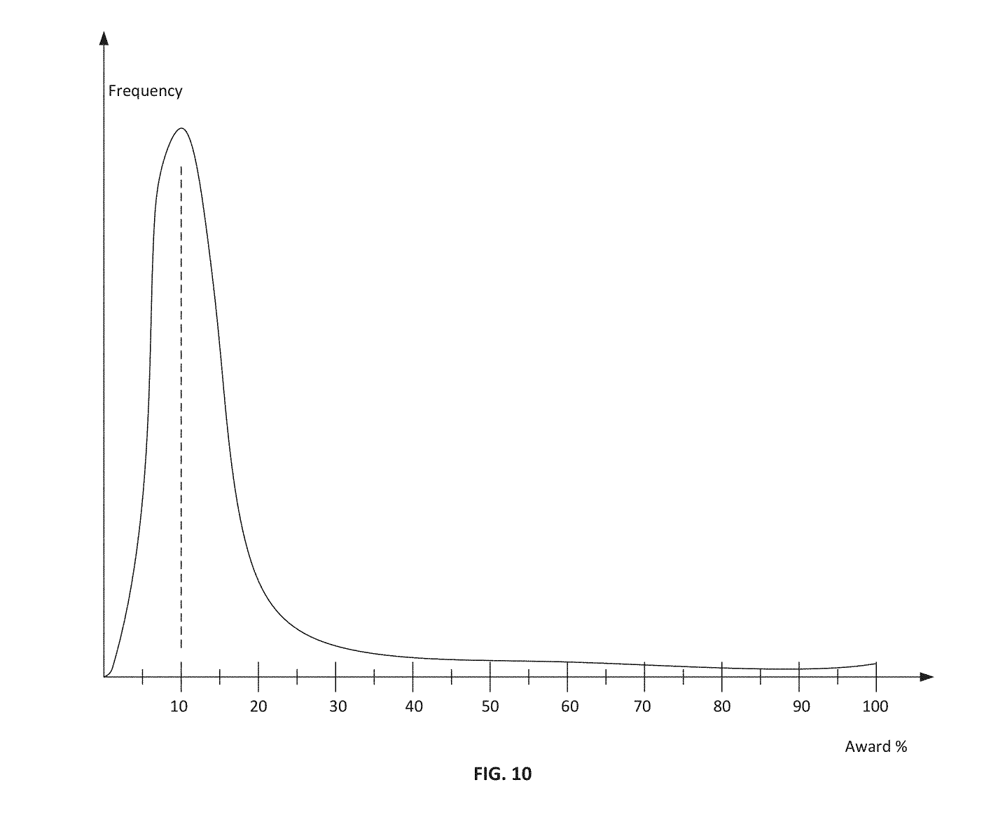

Attention is now directed to FIG. 10, which illustrates an exemplary distribution of variable rewards as a function of reward percentage. As mentioned above, a merchant is able to set a desired average reward percentage through the merchant portal 144 and this information becomes part of the merchant settings 148. The example of FIG. 10 reflects a reward distribution corresponding to a desired average reward of approximately 10% of the adjusted purchase amount (e.g., the purchase amount less any taxes or other fees). In addition to specifying an average reward amount, a merchant could, for example, also specify a maximum aware percentage, a minimum reward percentage, and/or an aggregate maximum reward over a predefined time period (e.g., after a predefined “maximum daily value” of rewards had been accrued in a given day, no further rewards would be granted that day to users claiming rewards from the applicable merchant). The imposition of these types of constraints by a merchant would generally result in a different reward distribution than that depicted in FIG. 10.

The module 110 may be configured by the operator of the platform 104 and/or participating merchants to change the shape of the reward distribution of FIG. 10 under various conditions. For example, it may be desired that the reward distribution for higher-value customers (from either the perspective of the operator of the platform 104 or from that of a particular merchant) be shaped to provide more favorable reward metrics (e.g., higher average rewards) for such customers.

Once a user of the application 250 has spun the virtual wheel presented by the application 250 or otherwise done all that is required by the application 250 to claim a reward, the amount of the claimed reward will typically immediately appear in the user's account with the variable rewards platform 104 in a pending status. Upon confirmation of the validity of the applicable uploaded receipt by both the operator of the variable rewards platform and the participating merchant, the reward will be made available in the user's account. Once the rewards amount in a user's account exceeds a predefined amount (e.g., $10.00), the funds transfer module 114 of the platform 104 may instruct a bank 180 maintaining an account used by the platform to transfer a payment equivalent to the accrued reward amount to the user's account in a bank 182. With respect to each merchant supported by the platform 104, the funds transfer module 114 may instruct bank 180 (i.e., the bank maintaining an account for the platform 104) to undertake an ACH debit transaction at regular intervals (e.g., once weekly) with respect to the merchant's bank 184 to cover the variable reward payments made by bank 180 to customers of the merchant.

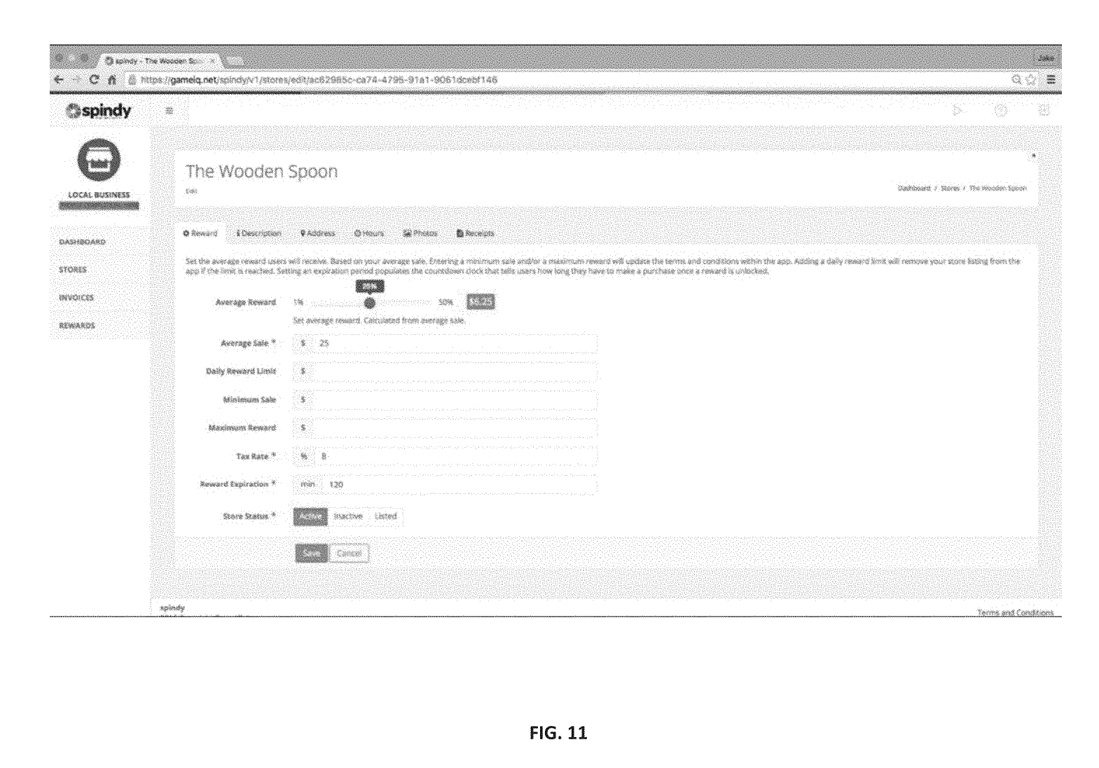

Attention is now directed to FIGS. 11-15, which depict exemplary user interface screens generated by the merchant portal 144 and rendered by an electronic computing device 188 of an administrator 140 for a participating merchant.

In particular, FIG. 11 is a user interface illustrating the reward settings for a participating merchant operating the “Wooden Spoon” store.

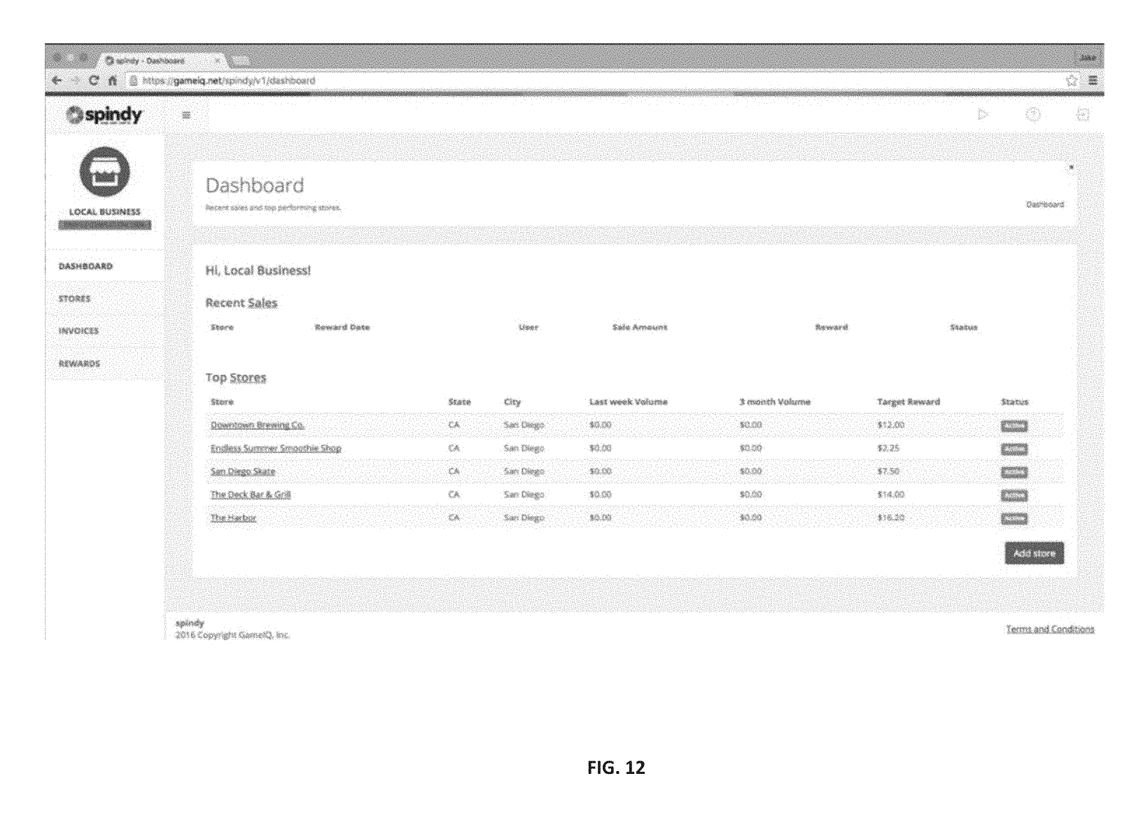

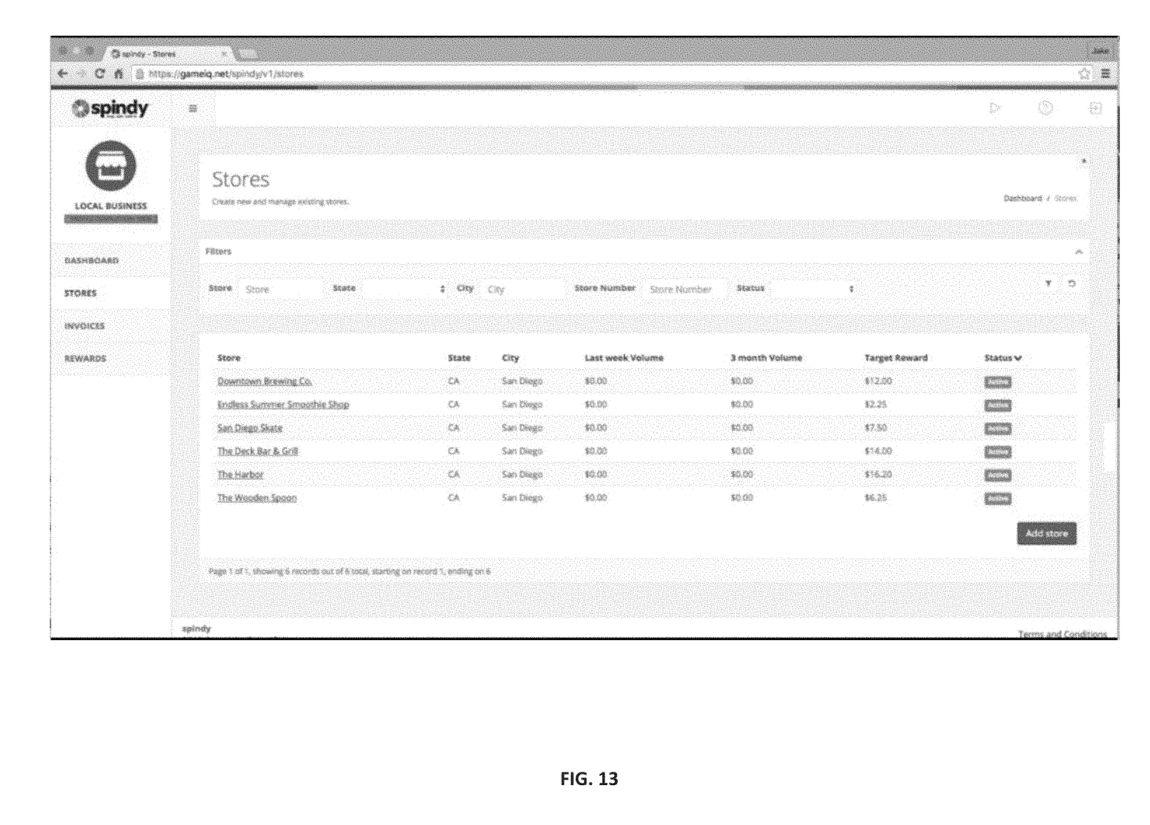

FIG. 12 illustrates an exemplary customer dashboard for a participating merchant which provides performance information for each of the merchant's top performing stores. Similarly, FIG. 13 illustrates an exemplary customer dashboard for a participating merchant which provides performance information for each of the merchant's stores, with the option to enter filter criteria.

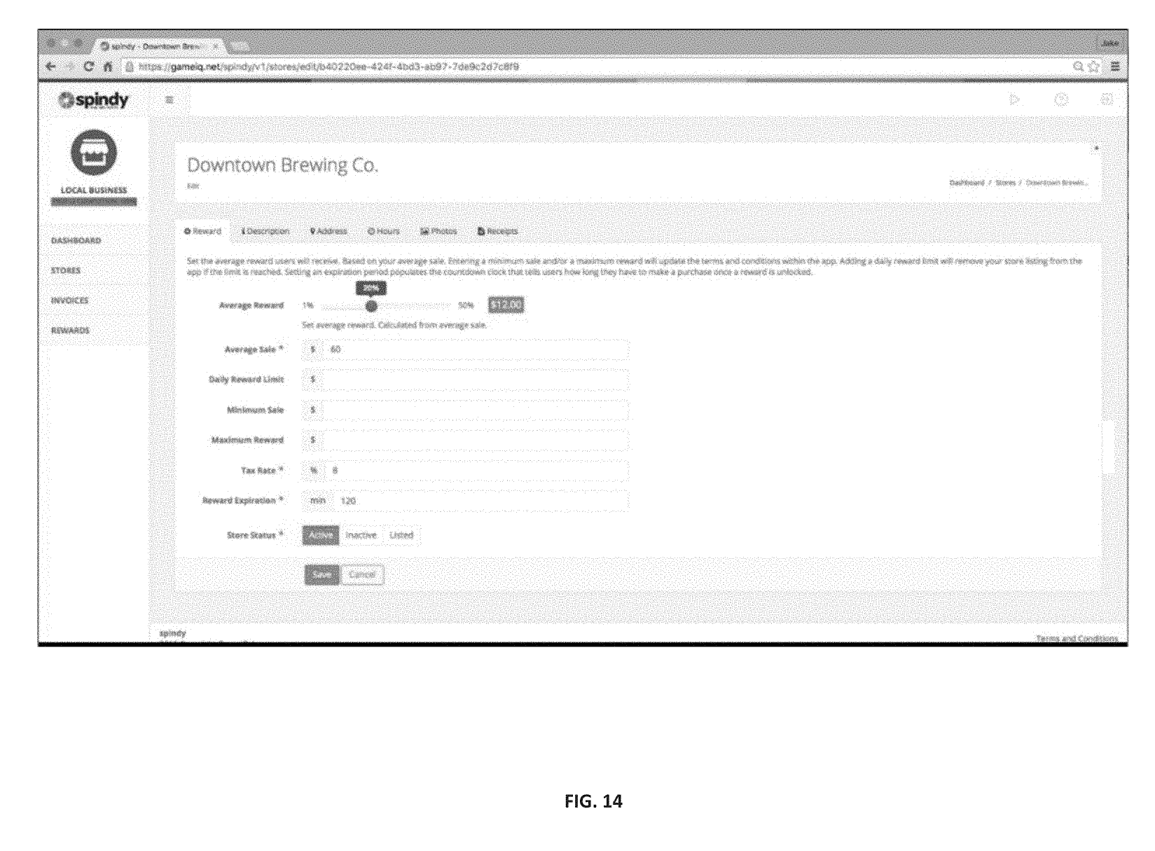

FIG. 14 is a user interface illustrating the reward settings for a participating merchant operating the “Downtown Brewing Co.”.

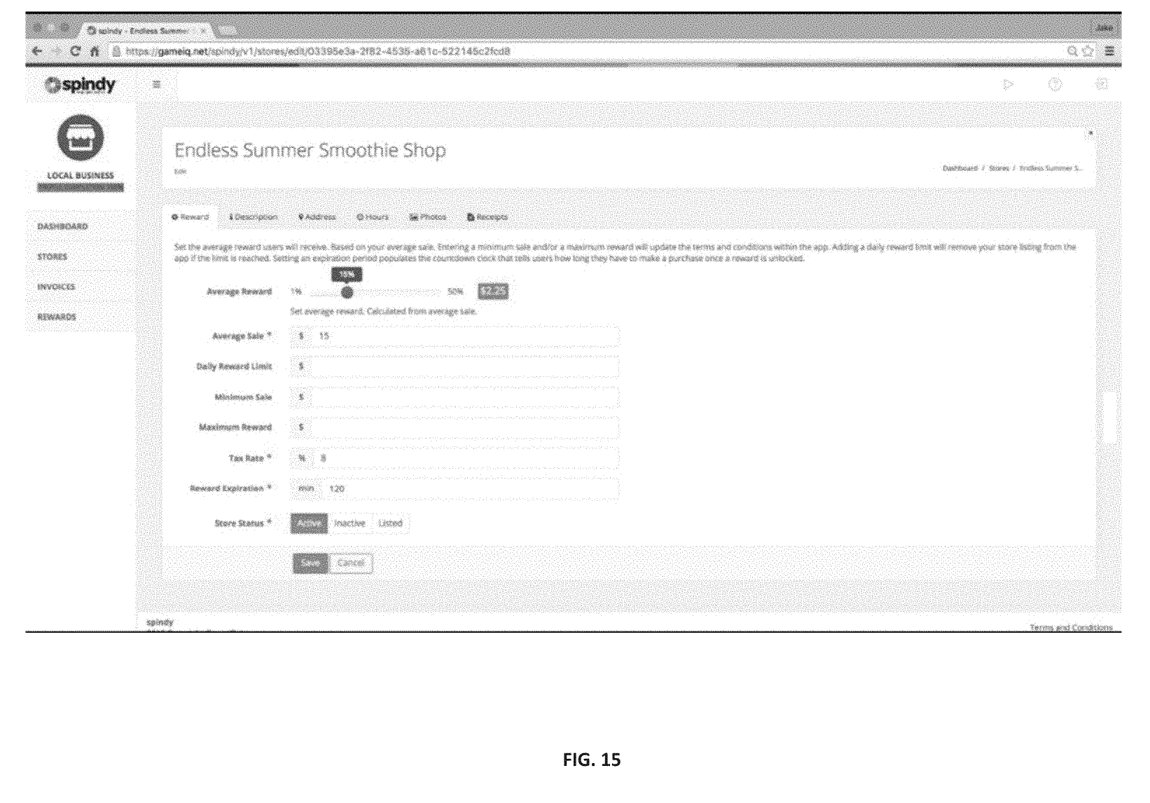

FIG. 15 is a user interface illustrating the reward settings for a participating merchant operating the “Endless Summer Smoothie Shop”.

In some embodiments users may accrue points or “virtual cash” from the operator of the platform 104 in lieu of, or in addition to, the variable cash rewards offered by merchants in connection with qualifying purchases.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above. Although various modules in the different devices are shown to be located in the processors of the device, they can also be located/stored in the memory of the device (e.g., software modules) and can be accessed and executed by the processors. Accordingly, the specification is intended to embrace all such modifications and variations of the disclosed embodiments that fall within the spirit and scope of the appended claims.

The various methods or processes outlined herein may be coded as software that is executable on one or more processors that employ any one of a variety of operating systems or platforms. Additionally, such software may be written using any of a number of suitable programming languages and/or programming or scripting tools, and may be compiled as executable machine language code or intermediate code that is executed on a framework or virtual machine.

In this respect, various inventive concepts may be embodied as a non-transitory computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The non-transitory computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

In addition, data structures may be stored in non-transitory computer-readable media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish a relationship between information in fields of a data structure, including through the use of pointers, tags or other mechanisms that establish relationship between data elements.

In addition, various inventive concepts may be embodied as one or more methods, of which an example has been provided. The acts performed as part of the method may be ordered in any suitable way. Accordingly, embodiments may be constructed in which acts are performed in an order different from illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A computer-implemented method of acquiring variable rewards via a user device, the method comprising:
displaying, by a variable rewards application executing on the user device, an offer for a variable reward associated with a merchant;
receiving, by the user device, user input causing the variable reward to be claimed;
using a camera of the user device to create an image of a receipt, the receipt corresponding to a purchase of a product or a service from the merchant;
electronically sending, by the user device, the image of the receipt over a network to a variable rewards platform;
receiving, at the user device, variable rewards information provided by the variable rewards platform; and
displaying, through a game interface presented by the variable rewards application, an amount of a variable reward included within the variable rewards information;
wherein a user account maintained by the variable rewards platform is credited based upon the amount of the variable reward.

2. The method of claim 1 further including:
displaying, through the game interface, a virtual wheel;
receiving, through the game interface, user input causing spinning of the virtual wheel;
wherein the virtual wheel is configured to display the amount of the variable reward.

3. The method of claim 2 wherein the virtual wheel is further configured to display amounts of corresponding alternate rewards included within the variable rewards information.

4. The method of claim 1 further including making the amount of the variable reward available in the user account upon confirming validity of the receipt.

5. The method of claim 1 further including displaying, through a user interface of the variable rewards application, program information identifying merchants participating in a variable rewards program through which variable rewards are obtainable through the variable rewards application.

6. The method of claim 5 wherein the program information includes at least one of a minimum purchase requirement and an average rebate amount.

7. The method of claim 5 wherein the program information includes at least one of a minimum purchase requirement and a maximum rebate amount.

8. The method of claim 5 wherein the amount of the variable reward ranges from 1% to 100% of a purchase prices of the product or the service.

9. The method of claim 1 wherein the amount of the variable reward is randomly generated by the variable rewards platform.

10. The method of claim 9 wherein the 1 wherein the amount of the variable reward is determined by the variable rewards platform based at least in part upon parameters provided by the merchant.

11. The method of claim 1 further including displaying, by the variable rewards application, a time within which a qualifying purchase must be made from the merchant after the variable reward is claimed.

12. An electronic device, comprising:
a processor;
a camera;
a display screen; and
a memory containing a variable rewards application having computer readable instructions which, when executed by the processor, cause the processor to:
display, on the display screen, an offer for a variable reward associated with a merchant;
receive, through a user interface presented by the variable rewards application, user input causing the variable reward to be claimed;
create, using the camera, an image of a receipt, the receipt corresponding to a purchase of a product or a service from the merchant;
electronically send the image of the receipt over a network to a variable rewards platform;
receive variable rewards information provided by the variable rewards platform; and
display, through a game interface presented by the variable rewards application, an amount of a variable reward included within the variable rewards information;
wherein a user account maintained by the variable rewards platform is credited based upon the amount of the variable reward.

13. The electronic device of claim 12 wherein the computer readable instructions, when executed by the processor, further cause the processor to
display, through the game interface, a virtual wheel;
receive, through the game interface, user input causing spinning of the virtual wheel;
wherein the virtual wheel is configured to display the amount of the variable reward.

14. The method of claim 13 wherein the virtual wheel is further configured to display amounts of corresponding alternate rewards included within the variable rewards information.

15. A computer-implemented method of acquiring variable rewards via a user device, the method comprising:
providing, to the user device, offer information to cause a variable rewards application executing on the user device to display an offer for a variable reward associated with a merchant;
receiving, from the user device, an indication that a user of the user device has indicated an intent to claim the variable reward by providing user input to the variable rewards application;
receiving, from the user device, an image of a receipt wherein the receipt corresponds to a purchase of a product or a service from the merchant and wherein a camera of the user device is used to create the image of a receipt;
determining, in response to receiving the image of the receipt, an amount of a variable reward corresponding to the purchase;
providing, to the user device, variable rewards information to cause the variable rewards application to display the amount of the variable reward;
wherein a user account maintained by the variable rewards platform is credited based upon the amount of the variable reward.

16. The method of claim 15 wherein the amount of the variable reward is displayed on a virtual wheel presented through a game interface of the variable rewards application.

17. The method of claim 16 wherein the variable rewards information provided by the variable rewards platform further includes alternate rewards information corresponding to alternate rewards displayed on the virtual wheel.

18. The method of claim 15 further including making the amount of the variable reward available in the user account upon confirming validity of the receipt.

19. The method of claim 15 further including providing, to the user device, program information identifying merchants participating in a variable rewards program through which variable rewards are obtainable through the variable rewards application.

20. The method of claim 19 wherein the program information includes at least one of a minimum purchase requirement and an average rebate amount.

21. The method of claim 15 further including randomly generating the amount of the variable reward.

22. The method of claim 15 further including:
receiving, through a merchant portal, reward parameters provided by the merchant;
determining the amount of the variable reward based at least in part upon the reward parameters.

23. The method of claim 15 further including:
receiving, from other user devices, indication that users of the other user devices have indicated intents to claim other variable rewards by providing user inputs to respective variable rewards applications respectively executing on the other user devices;
receiving, from the other user devices, images of other receipts wherein the other receipts correspond to other purchases of products or services from other merchants;
determining, in response to receiving the images of the other receipts, other amounts of variable rewards corresponding to the other purchases;
providing, to the other user devices, variable rewards information to cause each of the respective variable rewards applications to display one of the other amounts of variable rewards.
